(19) United States
(12) Patent Application Publication
(10) Pub. No.: US 2014/0054110 A1
(43) Pub. Date: Feb. 27, 2014

(54) METHOD FOR ACCESSING THE OUTER SURFACE OF WIND TURBINE TOWERS AND DEVICE FOR USE WITH THIS METHOD

(71) Applicants: Miguel Ángel Fernández Gómez, Madrid (ES); José Emilio Jimeno Chueca, Madrid (ES)

(72) Inventors: Miguel Ángel Fernández Gómez, Madrid (ES); José Emilio Jimeno Chueca, Madrid (ES)

(73) Assignee: INNEO TORRES, S.L., Madrid (ES)

(21) Appl. No.: 14/003,044

(22) PCT Filed: Mar. 2, 2012
(86) PCT No.: PCT/EP12/53680

§ 371 Date: Oct. 29, 2013

(30) Foreign Application Priority Data
Mar. 4, 2011 (ES) 9201130300

(51) Int. Cl. F03D 1/00

(52) U.S. Cl. CPC F03D 1/003
USPC 182/19; 182/37; 52/741.1

(57) ABSTRACT

Method for accessing the outer surface of wind turbine towers comprising the following steps: attaching an external peripheral rail on the outer surface of the tower; making an orifice above said rail; arranging a working platform on the base of the tower; inserting a cable reel in the orifice; raising the platform by driving the cable reel until it is near the peripheral rail; arranging means for suspension and horizontal displacement on the horizontal rail; connecting the platform to said means for suspension and horizontal displacement and displacing the platform as needed.

### FIELD OF THE INVENTION

The present invention relates to a method for accessing the outer surface of wind turbine towers and to a device for use with this method.

### BACKGROUND OF THE INVENTION

Wind turbines are well-known constructions used to obtain electricity from wind currents. They comprise a wind turbine assembly, hereby referred to for sake of simplicity as the gondola or nacelle (which comprises all the devices needed to convert the mechanical energy of wind currents into electrical energy and that can turn to align itself with said wind currents, in order to maximise the efficiency of the energy conversion), supported by a vertical structure known as the tower.

For the wind turbine to make an efficient use of the wind currents, these support towers must be considerably high, currently from 80 to 100 metres or even more.

In addition, it is necessary to avoid damage to the wind turbine due to the outdoor working conditions, aging or dirt. For this purpose, it is occasionally necessary to access the outer surface of the support towers for maintenance tasks.

However, the substantial height and volume of these constructions represent numerous problems for accessing a s specific point in their outer structure, particularly now that the sector intends to increase the efficiency of the turbines by increasing the height of the towers.

According to the state of the art, in order to access the outer surface of a wind turbine tower it is necessary to employ a laborious method and/or use relatively costly and sophisticated devices.

According to one of these methods of the state of the art, each time the outer surface of a wind turbine tower must be accessed, a large crane must be transported to the location of the tower, provided with a basket at the top end of its mast. Then the worker who must access the outer surface enters the crane basket, which is moved to the point of the tower that must be accessed.

Obviously, using a large crane implies a high cost. In addition, it is sometimes difficult to find a crane that is large enough and also fulfils the necessary safety requirements.

According to another method of the state of the art, each time the outer surface of a wind generator must be accessed a mainly annular scaffolding must be assembled concentrically to the base of the tower, subsequently raising it to the working point.

Assembling the parts that make up this scaffold is a long and tedious process that generally requires several days of work. In addition, the scaffold must have a larger diameter than the base of the supporting tower, so that it can be placed concentrically to it, and therefore must be very big, which increases costs considerably.

A third method of the state of the art involves accessing the outer surface of the tower by a working platform connected by cables to a crane. The crane is permanently attached to the outer surface of the nacelle and makes the working platform move up or down.

Although this crane can move the working platform vertically, by itself it cannot make the platform move horizontally. According to this method, in order to induce horizontal displacements it is necessary to rotate the entire nacelle of the wind turbine, thereby also turning the crane will (as it is attached to the nacelle) and the platform (as it is attached to the crane by a cable).

The need to rotate the entire nacelle reduces the efficiency of this access method. In addition, the cost of the crane and its installation atop the nacelle is also significant. A further drawback is that the nacelle must be turned by specialised workers who are often not part of the work team that wishes to access the outer surface of the tower.

A fourth method of the state of the art uses a working platform that hangs from reels or hoists located inside the nacelle, attached to the bottom of the frame. It is first necessary to make windows in the bottom surface of the nacelle casing for the cables to pass, and to allow the working platform to move around the tower it is also necessary to rotate the nacelle.

### SUMMARY OF THE INVENTION

A first object of the invention is to propose a method that involves installing, one time only, some fixed parts, and to make an orifice in a tower of the wind turbine, after which it is possible in successive occasions, in a short time on the order of 2 hours, to access the outer surface of the tower using only moving, reusable, simple and relatively inexpensive devices.

These fixed parts are an external peripheral rail and a reinforcement provided with anchoring means, the latter being arranged around an orifice made in the wall of the wind turbine with a size small enough to avoid compromising the structural integrity of the wind turbine tower. The remaining parts used in the method according to the invention are mobile, so that they can be retrieved and used again in subsequent occasions in which the method according to the invention is used.

This method according to the invention also prevents the need to rotate the nacelle and permanently install cranes, reels or motors in the outer surface of the wind turbine, leaving them exposed to the weather.

More specifically, this method comprises the following steps:

A) attaching an external peripheral rail to the wind turbine tower; making an orifice above said rail and finishing the orifice with a reinforcement provided with anchoring means;

B) arranging, on the base of the support tower, a working platform provided with:
first means for cable traction;
second means for cable traction provided with cable; and
support means meant to contact, at least partially, the surface of the support tower;

C) loading on the platform some means for suspension and horizontal displacement;

D) transporting to a point near the orifice a cable reel assembly that comprises:
a cable reel for rolling and unrolling a cable, as required, and
an arm with a cross section that allows it to pass through said orifice and also allows the cable to slide on the surface of said arm;

E) inserting the cable reel assembly in the orifice and anchoring it to the same using the anchoring means;

F) taking to the outside, through the arm, the end of the cable from the cable reel and lowering it to the base of the support tower, where the working platform is located;

G) connecting the cable from the cable reel to the first cable traction means and actuating said first cable traction means to raise the platform to a point near the peripheral rail;

H) coupling the means for suspension and horizontal displacement to said peripheral rail;

I) anchoring the free end of the cable of the second cable traction means to the suspension means of the suspension and horizontal displacement means;

J) releasing the cable of the cable reel from the first cable traction means;

K) coupling, at least partially, the support means to the wall of the wind turbine tower;

L) actuating the second cable traction means to displace the platform vertically or, alternatively, the horizontal displacement means to displace the platform horizontally, as many times as desired until the platform is placed at the desired position(s) of the outer surface of the wind turbine tower;

M) upon completion of the access to the outer surface of the tower, dismantling all the moving parts;

N) repeating steps B to M as desired.

Obviously, it is only necessary to carry out step A the first time that the method according to the invention is used, or even during the construction of the tower, prior to its assembly. In subsequent occasions, as the peripheral rail and the orifice with the reinforcement will already be installed in the wind turbine tower, it will only be necessary to complete steps B to N in order to execute said method.

On another hand, step L of this method makes it possible, once all the aforementioned steps have been completed, to access quickly one or more points of the outer surface of the tower. Once step L is reached, the displacement time from one point on the outer surface to another is short, on the order of several minutes.

A second object of the invention is to propose a device for accessing the outer surface of support towers, to be used with the method for accessing support towers described above.

Said device for accessing the outer surface of support towers comprises:
an external peripheral rail fitted on the outer surface of a wind turbine tower;
a small orifice made slightly above said peripheral rail;
a reinforcement provided with anchoring means arranged around said orifice;
a working platform provided with:
   first cable traction means for displacing a cable along a vertical direction;
   second cable traction means provided with a cable, for displacing the platform along a vertical direction; and
   support means for displacement of the working platform on the tower surface;
suspension and horizontal displacement means for coupling to the peripheral rail and its horizontal displacement along said peripheral rail;
a cable reel assembly provided with:
   a cable reel for rolling and unrolling a cable, as required, and
   an arm with a cross section that allows it to pass through the orifice made in the wind turbine tower.

### BRIEF DESCRIPTION OF THE DRAWINGS

These and other characteristics and advantages of the invention will become clear in the following description of several embodiments of the invention, provided as non-limiting examples only, with reference to the accompanying drawings, wherein:

FIG. 1 shows a first embodiment of a working platform arranged near the base of the wind turbine support tower, according to step B of the method of the invention;

FIG. 2 shows in greater detail the first embodiment of the working platform shown in FIG. 1;

FIG. 3 is a view of the coronation of the wind turbine tower showing a first embodiment of an external peripheral rail and a first embodiment of a cable reel assembly provided with a cable reel, inserted in a first embodiment of the orifice (not visible in the figure), according to step E of the method of the invention;

FIGS. 4a and 4b show the cable of the first embodiment of the cable reel assembly connected to an embodiment of the first cable traction means of the working platform, according to step G of the method of the invention;

FIG. 5a shows the working platform rising to the proximity of the peripheral rail by the action of the first cable traction means, at the end of step G of the method of the invention.

FIG. 5b shows a first embodiment of some suspension and horizontal displacement means coupled to said first embodiment of the peripheral rail and the free end of the cable of a first embodiment of the second cable traction means anchored to said first embodiment of the suspension means, after step J of the method of the invention;

FIG. 6 shows the first embodiment of the working platform moving vertically or horizontally on the wind turbine tower by the action of an embodiment of the second cable traction means and the horizontal displacement means, according to step L of the method of the invention;

FIG. 7 is a view of the coronation of the wind turbine tower that shows a second embodiment of an external peripheral rail and a second embodiment of the orifice, according to step A of the method of the invention;

FIG. 8 shows a second embodiment of some suspension and horizontal displacement means that are partially coupled to the said second embodiment of the peripheral rail, while a second embodiment of the first cable traction means is still connected by a cable to a second embodiment of the arm, according to step H of the method of the invention;

FIG. 9 is a view in which the second embodiment of the suspension and horizontal displacement means is already completely coupled to said second embodiment of the peripheral rail, the free end of the cable of the second cable traction means is already connected to the suspension means of the suspension and horizontal displacement means and the cable of the cable reel has been released from the first cable traction means; according to step J of the method of the invention; and

FIG. 10 shows the second embodiment of the working platform moving on the wind turbine tower by the action of an embodiment of the second cable traction means or the horizontal displacement means, according to step L of the method of the invention.

### DETAILED DESCRIPTION OF THE INVENTION

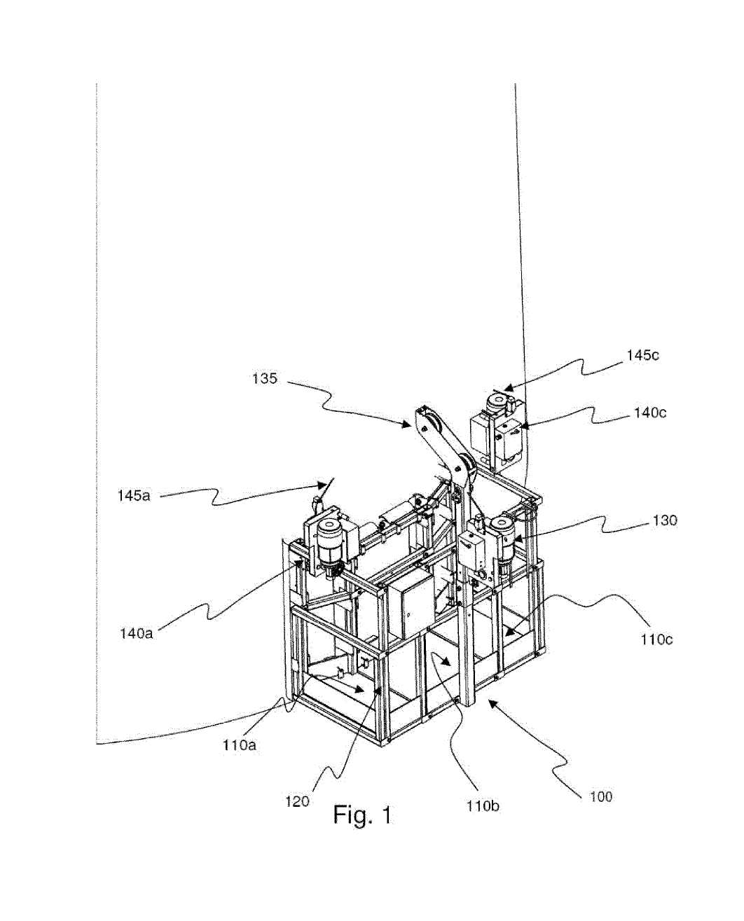

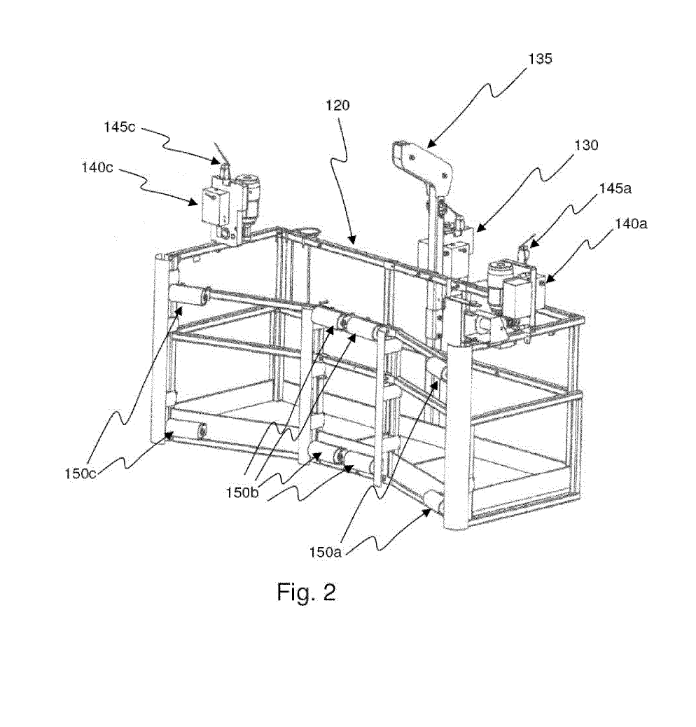

FIGS. 1 and 2 show a first embodiment of a working platform 100 arranged near the base of the wind turbine support tower.

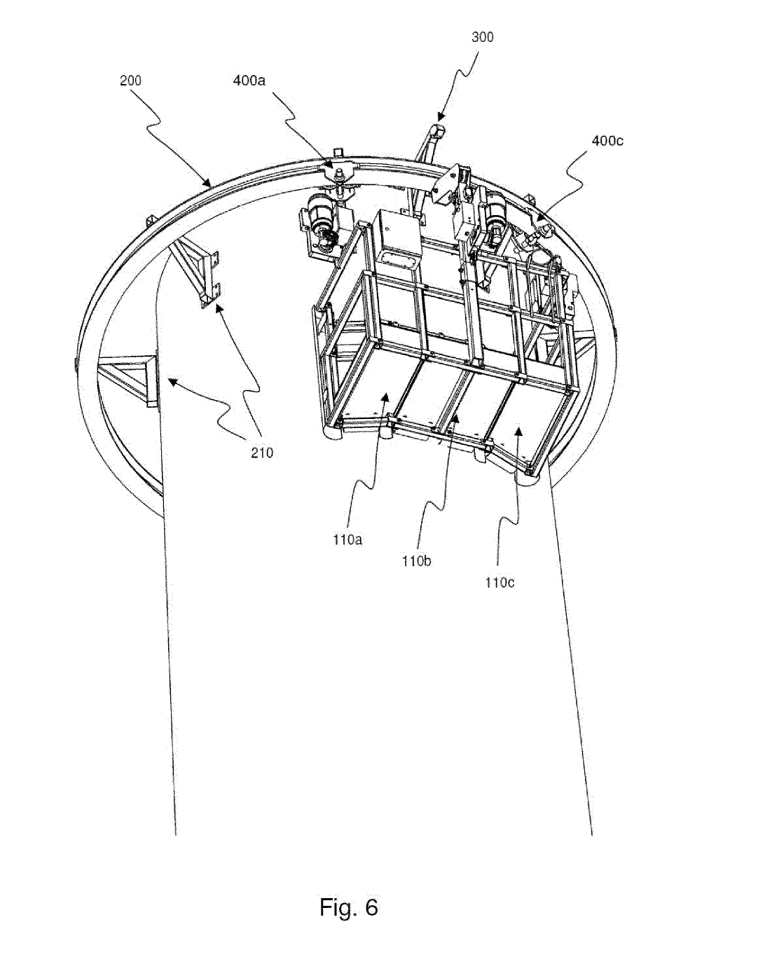

This working platform 100 has a base composed of a central floor part 110b, a left side floor part 110a and a right side floor part 110c. These parts 110a, 110b and 110c can be seen in greater detail in FIG. 6.

The left side part 110a and right side part 110c jut out at an angle to the central part 110b such that the base of the platform has a substantially polygonal shape with a curvature close to that of the mean diameter of the support tower.

In addition, the parts 110a and 110c can be attached to the part 110b in a fixed or hinged manner, the latter configuration allowing to change the angle between the parts so that the platform 110 can be better adjusted at all times to the surface of the support tower.

The working platform 100 is provided along its entire perimeter with a safety railing 120 to which are coupled the following elements:
first cable traction means 130, 135 comprising a central elevator motor 130 and connection means 135;
second cable traction means 140a, 140c, 145a and 145c comprising a left elevation motor 140a, a right elevation motor 140c, a cable 145a of the left elevator motor and a cable 145c of the right elevator motor;
support means 150a, 150b and 150c that comprise a plurality of left rollers 150a, central rollers 150b and right rollers 150c, these support means 150a, 150b and 150c also being provided with a mechanism (not shown in the figure) that allows placing the shaft of said rollers 150a, 150b and 150c in both a horizontal and vertical direction, with different ones contacting the outer surface of the support tower depending on the curvature of said tower.

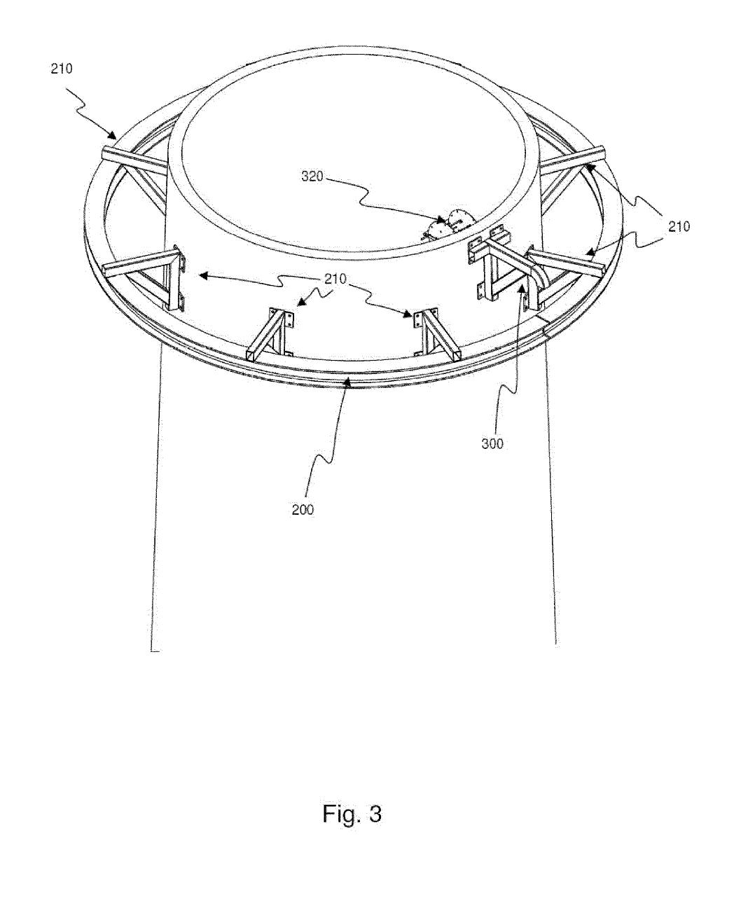

FIG. 3 shows a first embodiment of a peripheral rail 200, 210 comprising a plurality of posts 210 that jut out radially from the wall of the wind turbine tower. Each post 210 is anchored on one end to the wall of the wind turbine tower, in the area of the coronation of the tower, while on its other end it is firmly attached to a rail 200 arranged coaxially and externally to the surface of the support tower. The cross section of the rail 200 is basically H-shaped.

It is preferred to anchor the peripheral rail in the coronation area of the wind turbine tower so that it is possible to access a greater number of points on the outer surface of said tower.

In addition, FIG. 3 also shows a cable reel assembly 300, 320, 330 provided with a cable reel 320 on which is rolled a cable 330 (not visible in this figure) and an arm 300 with a cross section allowing to insert it in an orifice 310 (not visible in this figure), made in the wall of the support tower, and anchoring it to the same using anchoring means (not shown);

The dimensions of the orifice, typically on the order of 100 mm×100 mm, are small enough so that they do not compromise in any way the structural integrity of the support tower. In this embodiment the orifice also has a square shape.

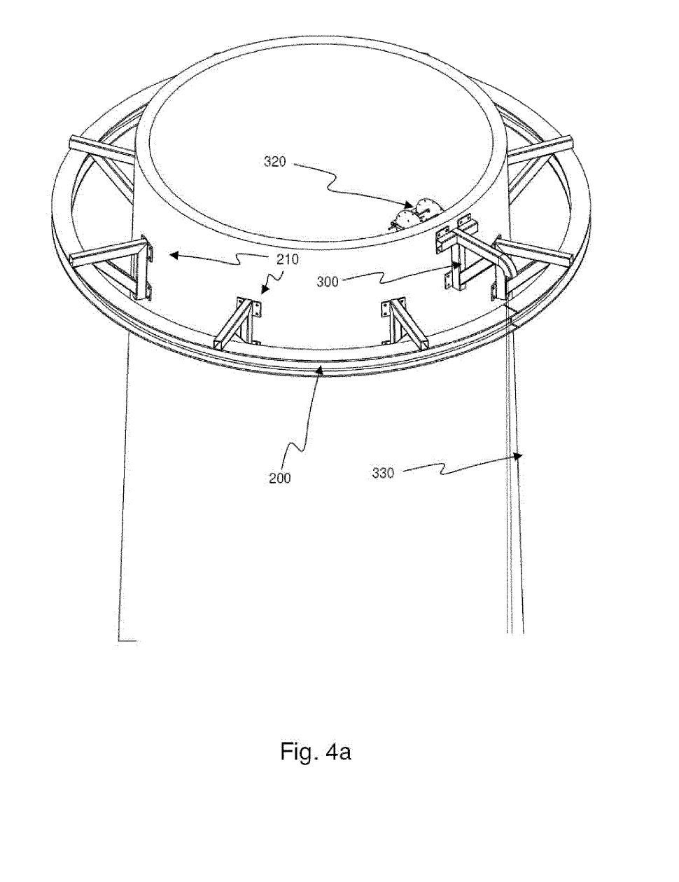

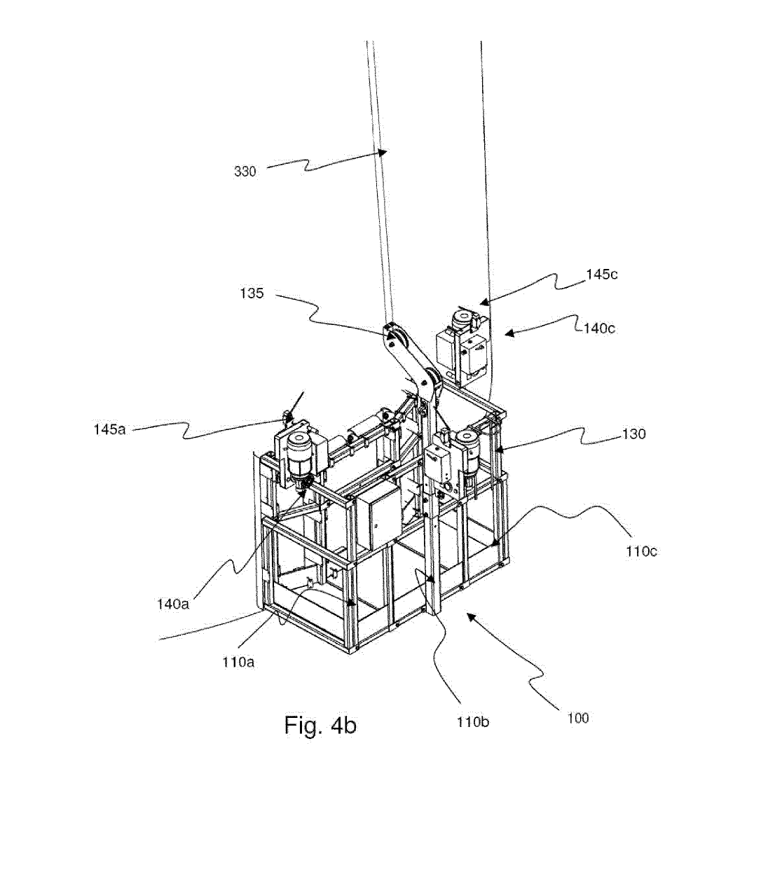

FIGS. 4a and 4b show how the cable 330, initially wound in the cable reel 320, has been lowered and connected to the connection means 135 of the first cable traction means 130, 135 of the working platform 100, according to step G of the method of the invention;

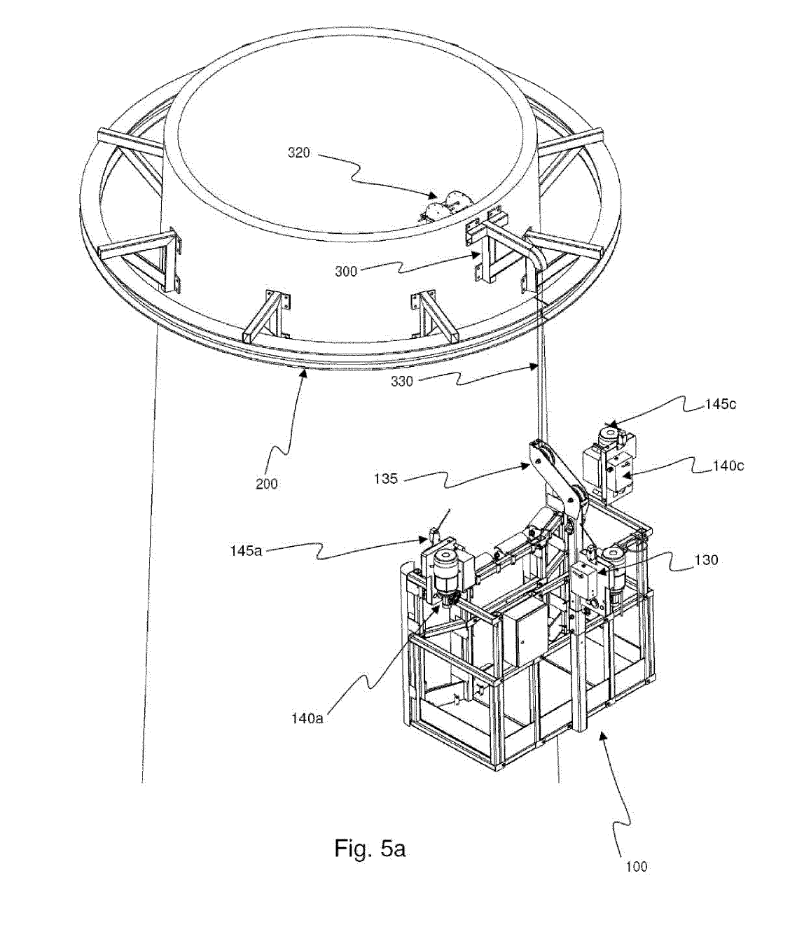

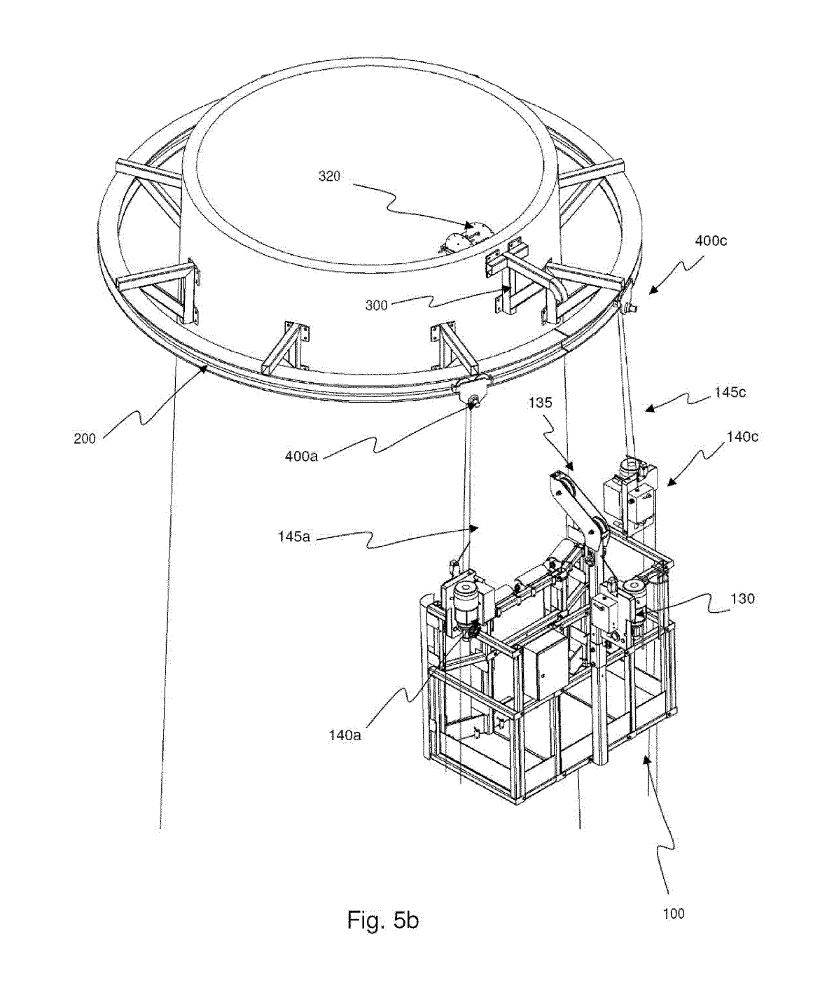

FIG. 5a shows in greater detail how the working platform 100 is lifted to the proximity of the peripheral rail 200, 210 by the action of the first cable traction means 130, 135.

FIG. 5b shows a first embodiment of the suspension and displacement means provided in the form of a left motorised carriage 400a for suspension and a right motorised carriage 400c for suspension, which in this step of the method are already coupled to the peripheral rail 200. In addition, the free end of the cable 145a of the left motor 140a and the free end of the cable 145c of the right motor 140c are also anchored to the left motorised carriage 400a for suspension and to the right motorised carriage 400c for suspension, respectively, and the cable 330 of the cable reel 320 has already been released from the first cable traction means 130, 135.

FIG. 6 shows the working platform 100 moving on the wind turbine tower by the action of the second cable traction means 140a, 140c, 145a, 145c or the left motorised carriage 400a and right motorised carriage 400c.

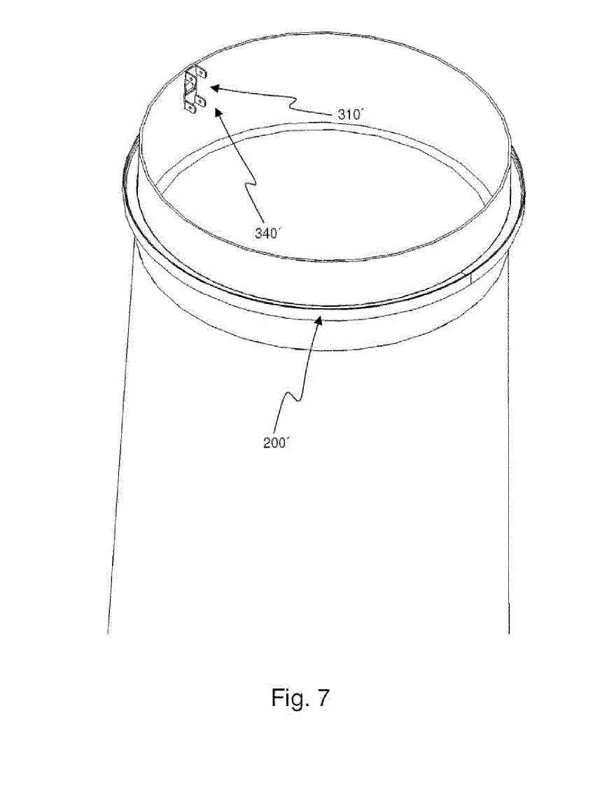

A second embodiment of the device of the invention will be described below, with reference to FIGS. 7 to 10. The elements similar to those of the first embodiment (described with reference to FIGS. 1 to 6) have been name using the same numerical references followed by a prime symbol (′).

FIG. 7 is a view of the coronation of the wind turbine tower showing a second embodiment of the outer peripheral rail 200′ and an orifice 310′.

In this embodiment it is not necessary to use posts, and the rail 200′ is attached directly to the surface of the support tower by adequate means, such as by welding. In addition, the cross section of the rail 200′ is basically T-shaped.

FIG. 7 also shows a square orifice 310′. As in the previous embodiment, the dimensions of the orifice are typically on the order of 100 mm×100 mm, and are therefore small enough not to compromise in any way the structural integrity of the support tower. At the edges of the orifice the reinforcement 340′ provided with anchoring means is arranged.

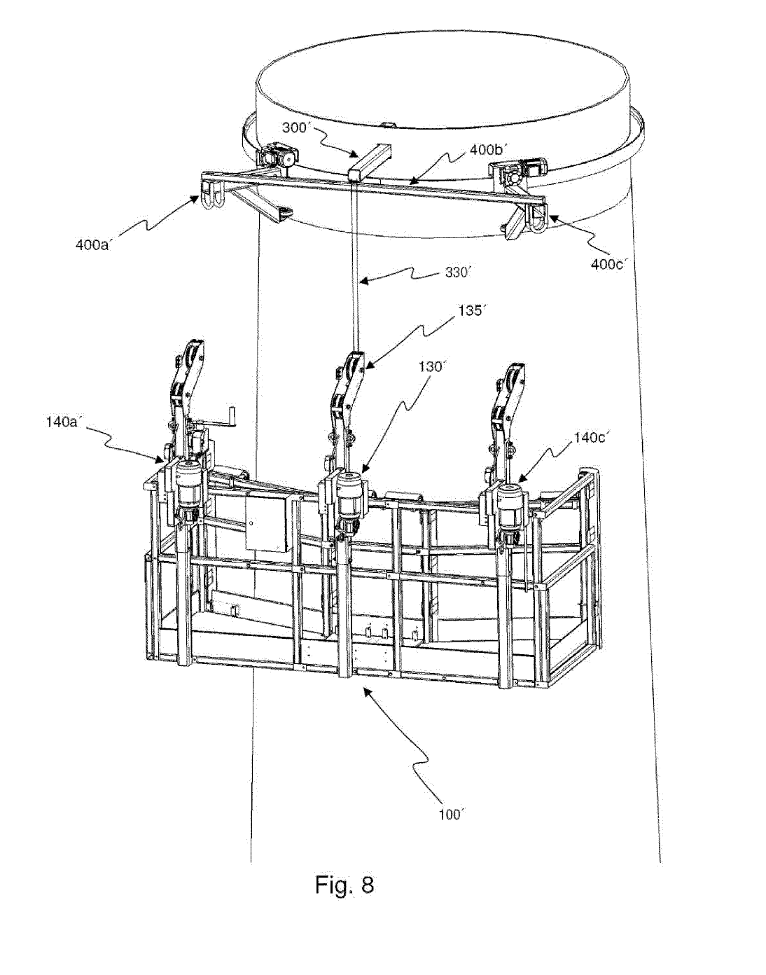

FIG. 8 shows how the action of the motor 130′ of the first cable traction means 130′, 135′ has raised the platform 100′ to the proximity of the rail 200′ with the aid of the double cable 330′, which has one end wound in the cable reel 320′ (not visible in the figure) and the other end attached to the connection means 135′.

FIG. 8 also shows how the left motorised carriage 400a′ and right motorised carriage 400c′ for suspension of the suspension and horizontal displacement means 400a′, 400b′, 400c′ have been coupled to the peripheral rail 200′ and are joined to one another by the crossbar 400b′.

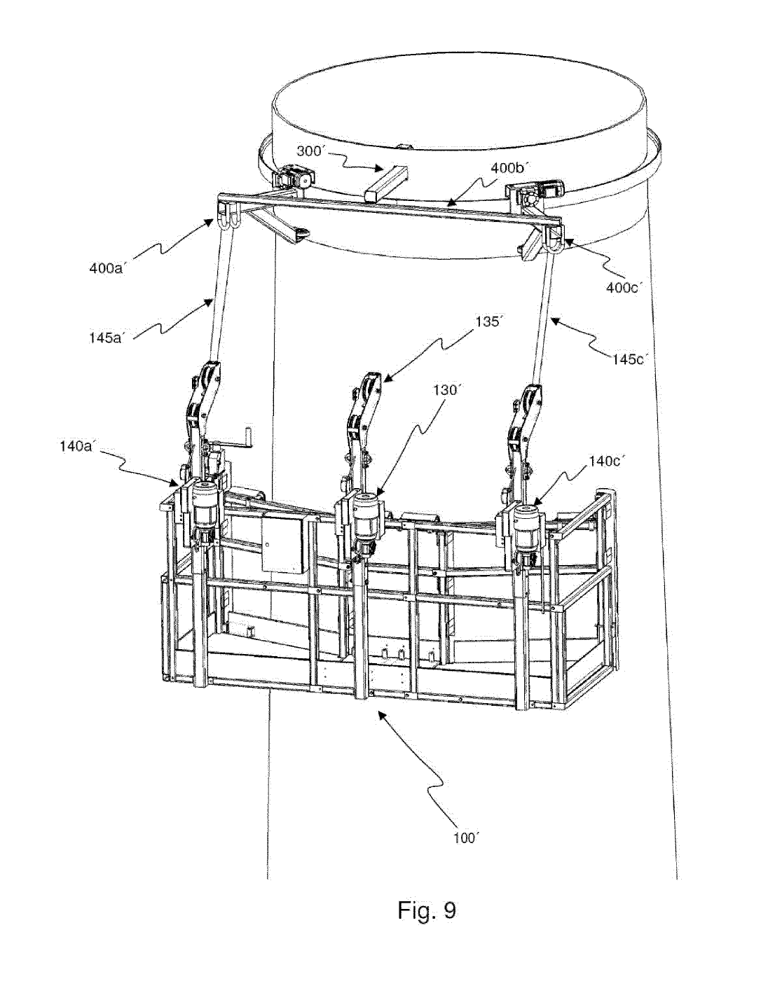

FIG. 9 shows how, after coupling the suspension and horizontal displacement means 400a′, 400b′, 400c′ to the peripheral rail 200′, the cable 330′ is released from the cable reel 320′ of the first cable traction means 130′, 135′.

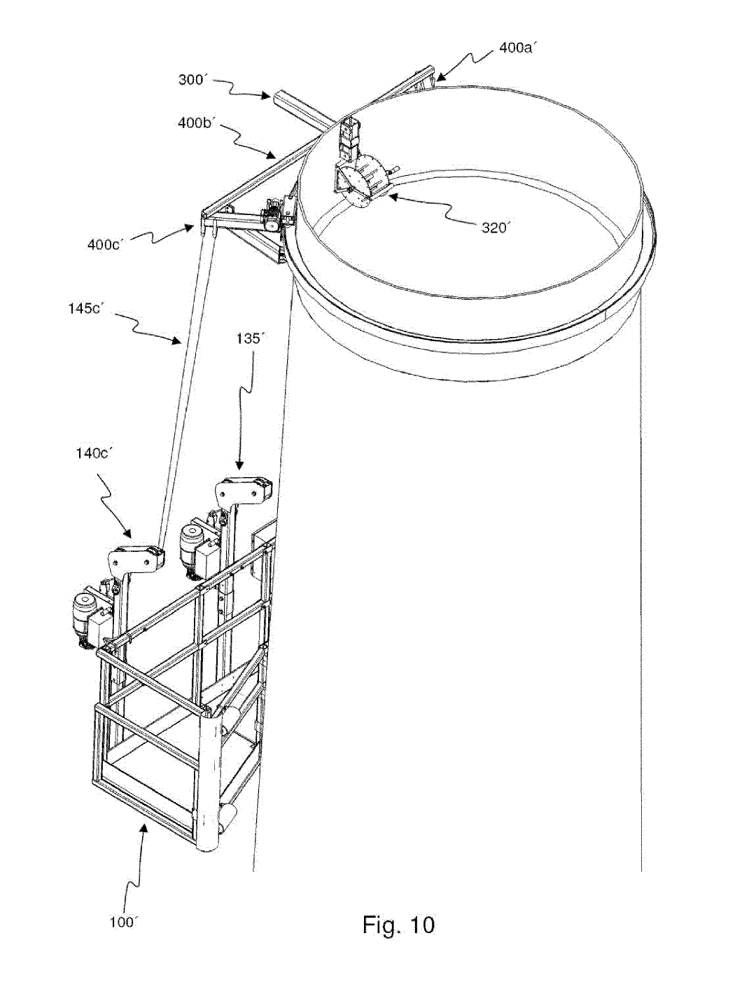

FIG. 10 shows the working platform 100′ moving on the tower of the wind turbine by the action of either the left motor 140a′ of the second cable traction means, the right motor 140c′ of the second cable traction means, the left motorised carriage 400a′ or the right motorised carriage 400c′.

The embodiments described herein are provided exclusively by way of example and in a non-limiting sense. A person skilled in the art will find obvious other embodiments included within the scope of the invention, as defined in the accompanying claims.

Thus, for example, the working platform 100 can optionally be provided with: drawers for holding objects; a fall arresting safety system provided with an additional cable; an overload detector that prevents lifting the platform if its load exceeds a specified limit; an emergency manual descent mechanism; an electromagnetic brake for blocking movement; a cable guide system with a position manually adjustable from the platform; intercommunication means; power outlets; and/or clearance lights.

In addition, said working platform 100 can be removable and/or hinged.

Also, the orifice can have geometries different from that described in the preferred embodiments, such as elliptical, polygonal or circular. An orifice with elliptical shape having its greater axis vertical is particularly preferred.

1. Method for accessing the outer surface of wind turbine towers, comprising the following steps:
A) attaching an external peripheral rail to the outer surface of a wind turbine tower; making an orifice above said rail and finishing the orifice with a reinforcement provided with anchoring means;
B) arranging, on the base of the support tower, a working platform provided with:
first cable traction means for displacing a cable along a vertical direction;
second cable traction means provided with a cable; and
support means meant to contact, at least partially, the surface of the support tower;
C) loading on the platform some means for suspension and horizontal displacement;
D) transporting to a height near the orifice a cable reel assembly provided with:
a cable reel on which is wound a cable, for winding and unwinding said cable, and
an arm with a cross section that allows it to pass through said orifice and also allows said cable to slide on the surface of said arm;
E) inserting the arm provided with the cable reel assembly in the orifice and anchoring it to the same using the anchoring means;
F) taking to the outside, through the arm, the end of the cable of the cable reel and lowering it to the base of the support tower, where the working platform is located;
G) connecting the cable of the cable reel to the first cable traction means and actuating said first cable traction means to raise the platform to a point near the peripheral rail;
H) coupling the suspension and horizontal displacement means to said peripheral rail;
I) anchoring the free end of the cable of the second cable traction means to the suspension means of the suspension and horizontal displacement means;
J) releasing the cable of the cable reel assembly from the first cable traction means;
K) coupling the support means to the wall of the wind turbine tower;
L) actuating the second cable traction means to displace the working platform vertically or, alternatively, the horizontal displacement means to displace the platform horizontally, as many times as desired, until said working platform is placed at the desired position(s) of the wind turbine tower;
M) upon completion of the access to the outer surface of the tower, dismantling all the moving parts;
N) Repeating steps B to M as desired.

2. Method for accessing the outer surface of wind turbine towers according to claim 1, wherein the external peripheral rail is attached at a height near to the coronation of the wind turbine tower.

3. Device for accessing the outer surface of wind turbine towers, comprising:
an outer peripheral rail;
an orifice made slightly above said peripheral rail;
a reinforcement provided with anchoring means arranged around said orifice;
a working platform provided with:
first cable traction means for displacing a cable along a vertical direction;
second cable traction means provided with a cable; and
support means meant to contact, at least partially, the surface of the support tower;
suspension and horizontal displacement means for coupling to the peripheral rail and its horizontal displacement along said peripheral rail;
a cable reel assembly provided with:
a cable reel on which is wound a cable, for winding and unwinding said cable, and
an arm with a cross section that allows it to pass through said orifice and also allows said cable to slide on the surface of said arm.

4. Device for accessing the outer surface of wind turbine towers according to claim 3, wherein the working platform has a base comprising a central floor part, a left side floor part and a right side floor part; the left side and right side parts jutting out at an angle to the central part such that the base of the platform has a substantially polygonal shape, with a curvature close to that of the mean diameter of the support tower.

5. Device for accessing the outer surface of wind turbine towers according to claim 3, wherein the working platform is removable and/or hinged.

6. Device for accessing the outer surface of wind turbine towers according to claim 3, wherein the working platform comprises at least one of the following elements:
drawers for objects;
a fall arrest safety system provided with an additional cable;
an overload detector that prevents lifting the platform if the load exceeds a specified limit;
an emergency manual descent system;
an electromagnetic brake for blocking the movement;
a cable guide system manually adjustable from the platform;
intercommunication means, power outlets, and/or clearance lights.

7. Device for accessing the outer surface of wind turbine towers according to claim 3, wherein the working platform is provided with a safety peripheral railing.

8. Device for accessing the outer surface of wind turbine towers according to claim 3, wherein:
the first cable traction means comprise a central elevator motor and connection means;
the second cable traction means comprise a left elevator motor, a right elevator motor, a cable of the left motor and a cable of the right motor; and
the support means comprise a plurality of left rollers, central rollers and right rollers, meant to contact at least partially the outer surface of the tower, said support means also being provided with a mechanism that allows placing the shaft of said rollers in both the horizontal and vertical directions.

9. Device for accessing the outer surface of wind turbine towers according to claim 3, wherein the orifice has dimensions on the order of 100 mm×100 mm and a square shape.

10. Device for accessing the outer surface of wind turbine towers according to claim 3, wherein the shape of the orifice is elliptical, elliptical with its greater axis vertical, polygonal or circular.

11. Device for accessing the outer surface of wind turbine towers according to claim 3, wherein the suspension and horizontal displacement means comprise a left motorised carriage for suspension and a right motorised carriage for suspension.

12. Device for accessing the outer surface of wind turbine towers according to claim 3, wherein the cross section of the rail is substantially H-shaped.

13. Device for accessing the outer surface of wind turbine towers according to claim 3, wherein the peripheral rail comprises a plurality of posts which jut out radially from the wall of the wind turbine tower; each post being anchored on one of its ends to the wall of the wind turbine tower and its other end being firmly attached to a rail arranged coaxially and externally to the surface of the support tower.

14. Device for accessing the outer surface of wind turbine towers according to claim 3, wherein the peripheral rail is attached directly to the surface of the support tower.

15. Device for accessing the outer surface of wind turbine towers according to claim 14, wherein the cross section of the peripheral rail is substantially T-shaped.

16. Device for accessing the outer surface of wind turbine towers according to claim 3, wherein the suspension means comprise a left motorised carriage for suspension and a right motorised carriage that are connected to each other by a crossbar.

17. Method for accessing the outer surface of wind turbine towers, comprising the following steps:
A) attaching an external peripheral rail to the outer surface of a wind turbine tower; making an orifice above said rail and finishing the orifice with a reinforcement provided with anchoring means;
B) arranging, on the base of the support tower, a working platform provided with:
first cable traction means for displacing a cable along a vertical direction;
second cable traction means provided with a cable; and
support means meant to contact, at least partially, the surface of the support tower;
C) loading on the platform some means for suspension and horizontal displacement;
D) transporting to a height near the orifice a cable reel assembly provided with:
a cable reel on which is wound a cable, for winding and unwinding said cable, and
an arm with a cross section that allows it to pass through said orifice and also allows said cable to slide on the surface of said arm;
E) inserting the arm provided with the cable reel assembly in the orifice and anchoring it to the same using the anchoring means;
F) taking to the outside, through the arm, the end of the cable of the cable reel and lowering it to the base of the support tower, where the working platform is located;
G) connecting the cable of the cable reel to the first cable traction means and actuating said first cable traction means to raise the platform to a point near the peripheral rail;
H) coupling the suspension and horizontal displacement means to said peripheral rail;
I) anchoring the free end of the cable of the second cable traction means to the suspension means of the suspension and horizontal displacement means;
J) releasing the cable of the cable reel assembly from the first cable traction means;
K) coupling the support means to the wall of the wind turbine tower;
L) actuating the second cable traction means to displace the working platform vertically or, alternatively, the horizontal displacement means to displace the platform horizontally, as many times as desired, until said working platform is placed at the desired position(s) of the wind turbine tower;
M) upon completion of the access to the outer surface of the tower, dismantling all the moving parts;
N) Repeating steps B to M as desired;
the method being carried out by a device for accessing the outer surface of wind turbine towers, comprising:
an outer peripheral rail;
an orifice made slightly above said peripheral rail;
a reinforcement provided with anchoring means arranged around said orifice;
a working platform provided with:
first cable traction means for displacing a cable along a vertical direction;
second cable traction means provided with a cable; and
support means meant to contact, at least partially, the surface of the support tower:
suspension and horizontal displacement means for coupling to the peripheral rail and its horizontal displacement along said peripheral rail;
a cable reel assembly provided with:
a cable reel on which is wound a cable, for winding and unwinding said cable, and
an arm with a cross section that allows it to pass through said orifice and also allows said cable to slide on the surface of said arm.
